(19) United States
(12) Patent Application Publication
(10) Pub. No.: US 2003/0021508 A1
(43) Pub. Date: Jan. 30, 2003

(54) Bearing journal for bicycles

(76) Inventor: Kun-Yuan Lee, Fengyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/910,888

(22) Filed: Jul. 24, 2001

(51) Int. Cl. F16C 13/00

(52) U.S. Cl. 384/545

(57) ABSTRACT

A bearing journal for bicycles includes a lower race having two stops extending from an outer periphery of the lower race and an upper race having a skirt extending from an outer periphery thereof. A bearing is received between the lower race and the upper race. A protrusion extends inward from an inner periphery of the skirt which encloses the two stops. The steering tube of the front fork extends through the bearing journal and is connected to a handlebar stem. When the handlebar is rotated 180 degrees, the upper race co-rotated with the handlebar is stopped by the contact between the protrusion and one of the stops.

### FIELD OF THE INVENTION

The present invention relates to a bearing journal for bicycles and the lower race has two stops on an outer periphery thereof and the upper race has a protrusion extending inward therefrom which is stopped by contacting one of the stops to restrict the handlebar to rotate over 180 degrees.

### BACKGROUND OF THE INVENTION

There are two sets of conventional bearing journals connected on two ends of the head tube of a bicycle. Each of the baring journals includes a lower race and an upper race, and a bearing is engaged between the lower race and the upper race. The steering tube of the front fork of the bicycle extends through the two bearing journals and is connected to the handlebar stem which is able to be pivoted to control the directions to turn of the bicycle. The conventional bearing journals cannot restrict the degrees of the rotation of the handlebar so that if the handlebar is over-rotated, the brake cables will be tangled and pulled tightened to suddenly stop the bicycle. This could lead a dangerous fall to the rider.

### SUMMARY OF THE INVENTION

In accordance with one aspect of the present invention, there is provided a bearing journal for bicycles which comprises a lower race having two stops extending from an outer periphery of the lower race and an upper race having a skirt extending from an outer periphery thereof. A protrusion extends inward from an inner periphery of the skirt. A bearing is received between the lower race and the upper race. The two stops are enclosed by the skirt. A neck extends from a top surface of the upper race and a locking nut is mounted to the neck.

The primary object of the present invention is to provide a bearing journal for bicycles wherein the handlebar is restricted to be rotated within 180 degrees.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bearing journal of the present invention used on a bicycle;

FIG. 2 is an exploded view to show the bearing journal of the present invention;

FIG. 3 is an exploded view to show the lower race, the bearing and the upper race of the bearing journal of the present invention;

FIG. 4 is a top plan view to show the upper race is not yet rotated, and FIG. 5 is a top plan view to show the upper race is rotated and the protrusion is stopped by one of the two stops.

### DETAILED DESCRIPTION OF THE PREFERRED EMBODIMENT

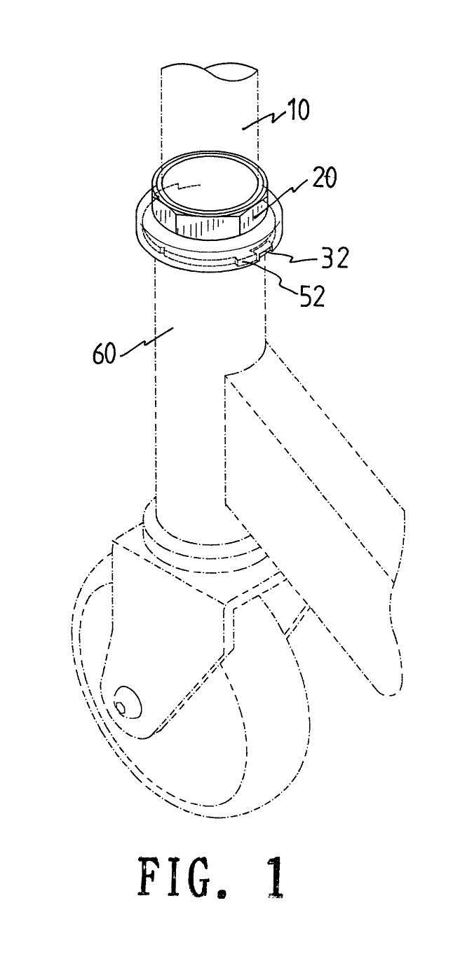

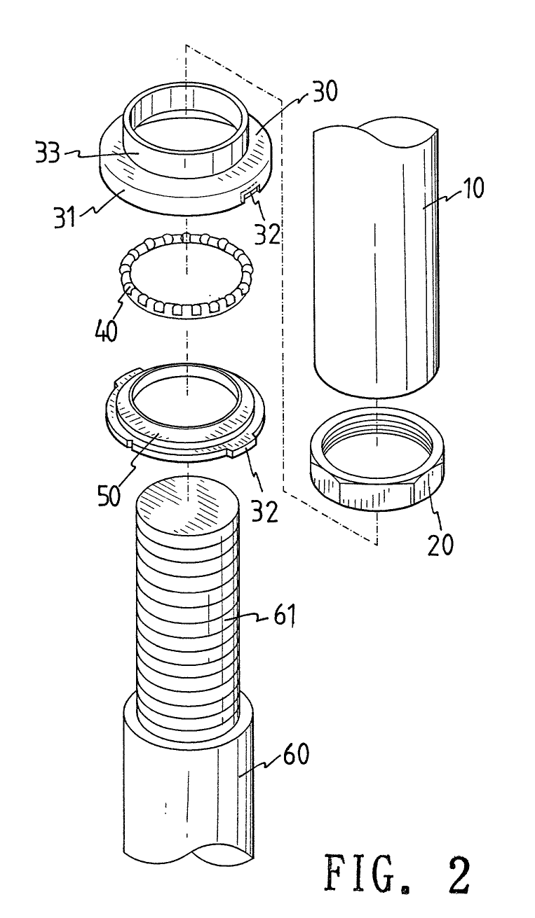

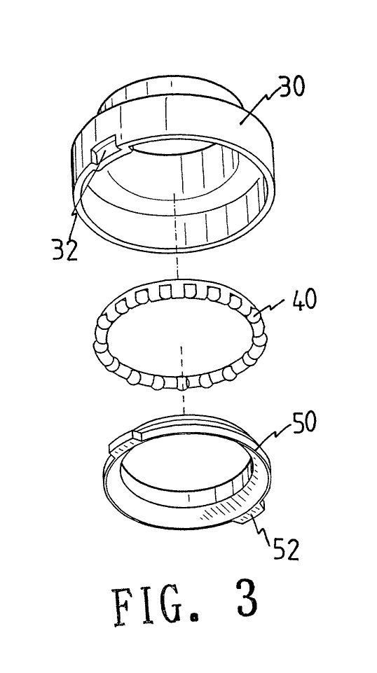

Referring to FIGS. 1 to 3, the bearing journal of the present invention is installed to each one of two ends of the head tube 60 of a bicycle. A threaded steering tube 61 of the front fork 60 extends through the bearing journals on two ends of the head tube 60 and the handlebar 10 is connected to the steering tube 61. The bearing journal comprises a lower race 50 having two stops 52 extending from an outer periphery of the lower race 50, and an upper race 30 having a skirt 31 extending from an outer periphery thereof. A protrusion 32 extends inward from an inner periphery of the skirt 31 and a bearing 40 is received between the lower race 50 and the upper race 30. The two lower race 50 including the two stops 52 are enclosed by the skirt 31. A neck 33 extends from a top surface of the upper race 30 and a locking nut 20 is mounted to the neck 33.

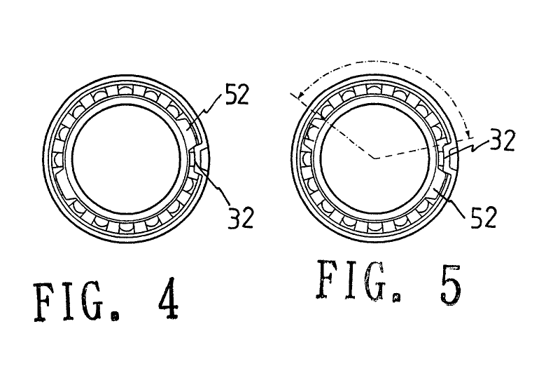

As shown in FIG. 4, when the handlebar stem 10 is not rotated or is rotated within 180 degrees, the upper race 30 is co-rotated with the handlebar stem 10. Referring to FIG. 5, when the handlebar stem 10 is to be rotated over 180 degrees, the protrusion 32 on the upper race 30 will be stopped by one of the two stops 52 on the lower race 50.

The stops 52 are not exposed and enclosed by the skirt 31 of the upper race 30 so that they will not tangle with objects. The handlebar stem 10 is restricted to be rotated over 180 degrees so as to ensure the front wheel of the bicycle will not be turned to be transverse relative to the forging direction.

While we have shown and described the embodiment in accordance with the present invention, it should be clear to those skilled in the art that further embodiments may be made without departing from the scope of the present invention.

What is claimed is:

1. A bearing journal for bicycles, comprising:
a lower race having two stops extending from an outer periphery of said lower race;
an upper race having a skirt extending from an outer periphery thereof and a protrusion extending inward from an inner periphery of said skirt, said a bearing received between said lower race and said upper race, said two stops enclosed by said skirt, a neck extending from a top surface of said upper race, and
a locking nut mounted to said neck.
